(19) United States
(12) Patent Application Publication
(10) Pub. No.: US 2025/0166368 A1
(43) Pub. Date: May 22, 2025

(54) CONTENT CREATION

(71) Applicant: Sony Interactive Entertainment Inc., Tokyo (JP)

(72) Inventors: Patrick John Connor, London (GB); Daniel Spong, London (GB)

(21) Appl. No.: 18/943,855

(22) Filed: Nov. 11, 2024

(30) Foreign Application Priority Data
Nov. 22, 2023 (GB) 2317841.1

(51) Int. Cl. G06V 10/86; A63F 13/60; G06T 15/04; G06T 19/20

(52) U.S. Cl. CPC G06V 10/86; A63F 13/60; G06T 15/04; G06T 19/20

(57) ABSTRACT

A computer-implemented method comprises obtaining a set of initial graphics assets for a video game, an initial graphics asset comprising at least initial model data for an object, obtaining text data from one or more data sources, inputting at least some of the text data to a machine learning model, generating one or more respective images in dependence on the text data using the machine learning model, and modifying the set of initial graphics assets for the video game in dependence upon one or more of the respective images generated using the machine learning model.

### FIELD OF THE DISCLOSURE

The present disclosure relates to data processing. In particular, the present disclosure relates to data processing for generating content for video games.

### DESCRIPTION OF THE PRIOR ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior against the present disclosure.

The creation and development of content for computer-generated environments, such as virtual reality environments, can be a laborious process requiring significant development time. Computer generated environments for video games typically use a range of assets. During development of content for a video game, content creation tools are typically used by a developer to create virtual objects by specifying graphics assets such as model data and texture data, as well as potentially other assets to be used for the virtual objects such as audio data and haptic data. With increasing size, complexity and realism of video games and their associated computer generated environments, creation of assets is becoming ever more time consuming for developers.

It is an aim to improve content generation for video games.

It is in the context of the above arrangements that the present disclosure arises.

Various aspects and features of the present disclosure are defined in the appended claims and within the text of the accompanying description. Example embodiments include at least a method, data processing apparatus, computer program and a machine-readable, non-transitory storage medium which stores such a computer program.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram illustrating an example of an entertainment device;

FIG. 2 is a schematic flowchart illustrating a method for modifying a set of initial graphics assets;

FIG. 3 is a schematic diagram illustrating a data processing apparatus for performing the method; and

FIG. 4 and FIG. 5 are schematic flowcharts illustrating possible techniques for modifying the set of initial graphics assets.

### DESCRIPTION OF THE EMBODIMENTS

In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

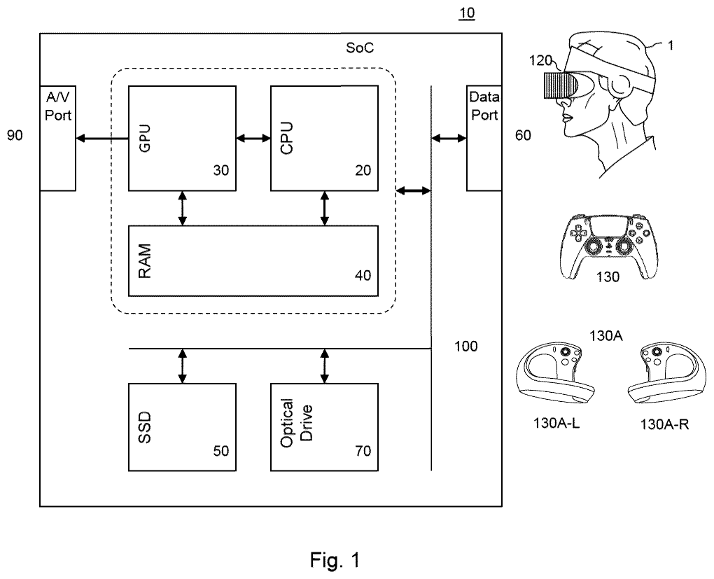

Referring now to the drawings, wherein like reference numerals designate identical or corresponding parts, FIG. 1 shows an example of an entertainment device 10 which may be a computer or video game console, for example.

The entertainment device 10 comprises a central processor 20. This may be a single or multi core processor, for example comprising eight cores as in the PS5. The entertainment device also comprises a graphical processing unit or GPU 30. The GPU can be physically separate to the CPU, or integrated with the CPU as a system on a chip (SoC).

The GPU, optionally in conjunction with the CPU, may process data and generate video images (image data) and optionally audio for output via an AV output. Optionally, the audio may be generated in conjunction with or instead by an audio processor (not shown).

The video and optionally the audio may be presented to a television or other similar device. Where supported by the television, the video may be stereoscopic. The audio may be presented to a home cinema system in one of a number of formats such as stereo, 5.1 surround sound or 7.1 surround sound. Video and audio may likewise be presented to a head mounted display unit worn by a user.

The entertainment device also comprises RAM 40, and may either have separate RAM for each of the CPU and GPU, or shared RAM. The or each RAM can be physically separate, or integrated as part of an SoC. Further storage is provided by a disk 50, either as an external or internal hard drive, or as an external solid state drive, or an internal solid state drive.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90, or through one or more of the wired or wireless data ports 60.

An example of a device for displaying images output by the entertainment device is a head mounted display ‘HMD’ 120 worn by a user 1. The images output by the entertainment device may be displayed using various other devices—e.g. using a conventional television display connected to A/V ports 90.

Where components are not integrated, they may be connected as appropriate either by a dedicated data link or via a bus 100.

Interaction with the device is typically provided using one or more handheld controllers 130, 130A and/or one or more VR controllers 130A-L,R in the case of the HMD. The user typically interacts with the system, and any content displayed by, or virtual environment rendered by the system, by providing inputs via the handheld controllers 130, 130A. For example, when playing a game, the user may navigate around the game virtual environment by providing inputs using the handheld controllers 130, 130A.

FIG. 1 therefore provides an example of a data processing apparatus suitable for executing an application such as a video game.

The operations to be discussed below relate to techniques for generating content for video games. In particular, the operations to be discussed below use machine learning to generate one or more images in dependence upon text data obtained from one or more sources. The operations to be discussed below also provide a set of initial graphics assets for a video game and perform modification with respect to the set of initial graphics assets for the video game in dependence upon one or more of the images generated using machine learning.

The set of initial graphics assets for the video game may correspond to a complete set of a graphics assets for an existing video game. The set of initial graphics assets may correspond to a complete set of graphics assets for a portion of an existing video game, such as a scene, level and/or a spatial portion of a computer generated environment. Hence, the set of initial graphics assets may correspond to a complete set of graphics assets for which each initial graphics asset comprises at least initial model data and initial texture data for one or more respective video game objects. The model data may comprise one or more of 2D model data, 3D model data, and examples of suitable model data include polygonal mesh data and/or point cloud data.

In some cases, the set of initial graphics assets may correspond to a template set of graphics assets for a portion of a video game. The template set of graphics assets (also referred to as a base set of assets) may be specifically created so as to serve as a template to be used according to the techniques to be discussed below. The template set of graphics assets may comprise a set of initial graphics assets for which each or at least some of the initial graphics assets comprise at least initial model data for one or more respective video game objects. Optionally, each initial graphics asset may also comprise initial texture data for the respective object. For example, the template set of graphics assets may include a minimum set of graphics assets required for playing the video game (or portion thereof) whilst being intended to be modified according to the techniques below to provide a more feature rich experience.

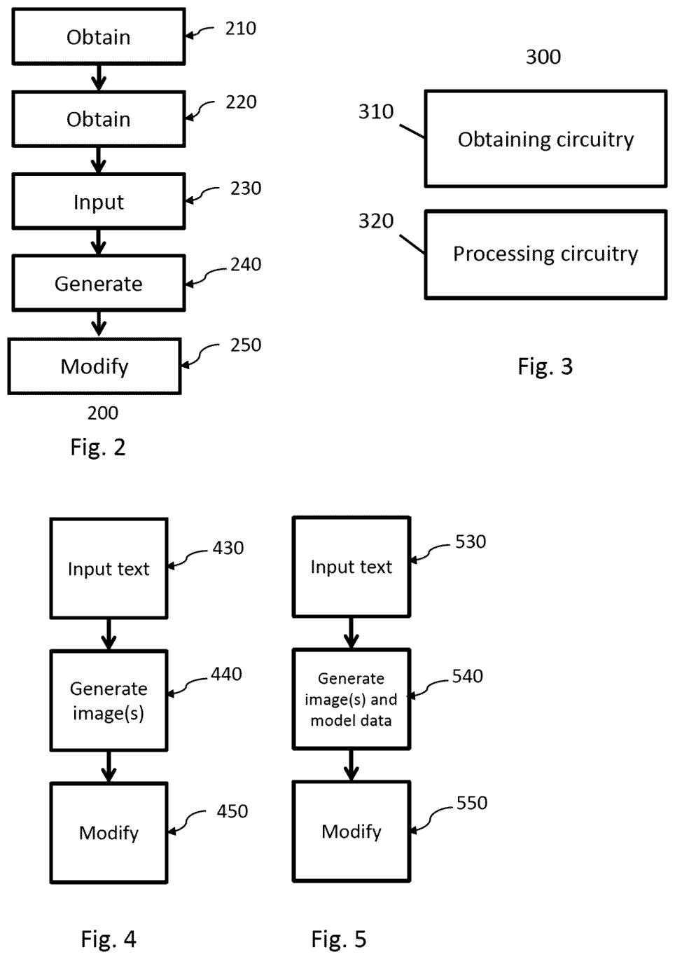

FIG. 2 is a schematic flowchart illustrating a computer-implemented method 200 in accordance with embodiments of the disclosure. The method comprises:
obtaining (at a step 210) a set of initial graphics assets for a video game, an initial graphics asset comprising at least initial model data for an object;
obtaining (at a step 220) text data from one or more sources;
inputting (at a step 230) at least some of the text data to a machine learning model;
generating (at a step 240) one or more respective images in dependence on the text data using the machine learning model; and
modifying (at a step 250) the set of initial graphics assets for the video game in dependence upon one or more of the respective images generated using the machine learning model.

The method 200 may be performed by any suitable data processing apparatus. Examples of suitable data processing apparatus include servers and general purpose computing devices. In some embodiments of the disclosure, a user device, such as the entertainment device 10 discussed with respect to FIG. 1, may be operable to perform the method 200.

FIG. 3 is a schematic diagram illustrating a data processing apparatus 300 in accordance with embodiments of the disclosure. The data processing apparatus 300 comprises obtaining circuitry 310 and processing circuitry 320. The obtaining circuitry 310 is operable to obtain a set of initial graphics assets for a video game and text data from one or more sources, an initial graphics asset comprising at least initial model data for an object. The processing circuitry 320 is operable to: input at least some of the text data to a machine learning model; generate one or more respective images in dependence on the text data using the machine learning model; and modify the set of initial graphics assets for the video game in dependence upon one or more of the respective images generated using the machine learning model.

The data processing apparatus 300 may for example be a server device. Alternatively, the data processing apparatus 300 may for example be a user device. In some examples, the data processing apparatus 30 may be an entertainment device, such as a video game console.

### Initial Graphics Assets

The set of initial graphics assets for the video game may be stored by a content server or other similar storage source and obtained therefrom in response to a request. Alternatively, or in addition to, the set of initial graphics assets for the video game may be stored by storage circuitry provided as part of the data processing apparatus 300. Hence, the set of initial graphics assets for the video game may be obtained from a remote device or from a local storage. The data processing apparatus 300 may for example firstly download the set of initial graphics assets for a video game from a source device and store the set of initial graphics assets using storage circuitry (not shown in FIG. 3).

The set of initial graphics assets may correspond to an existing video game (i.e. a complete video game or complete part of a video game). Any suitable existing video game such as a first person shooter, racing game, role playing game and so on may have a set of assets which have been generated in advance and which are to be used during execution of the video game for displaying images depicting a computer generated environment. Such an asset set may be obtained at the step 210.

The set of initial graphics assets may correspond to a portion of an existing video game (e.g. level, scene or predetermined spatial portion of a computer-generated environment). Hence, for example, a first set of initial graphics assets may correspond to a first portion of an existing video game (e.g. one level) and a second set of initial graphics assets may correspond to a second portion of the existing video game (e.g. another level). More generally, a plurality of respective sets of initial graphics assets may each correspond to a different portion of a same video game and one or more of the plurality of respective sets may be obtained for use in the method 200 when desired. For example, the apparatus 300 may be a game console device, and in response to a user requesting to play a given video game, a set of initial graphics assets corresponding that the given video game (or portion thereof) may be obtained and used according to the method 200 to obtain a modified set of graphics assets to be used during execution of the video game by the apparatus 300.

In some cases, the set of initial graphics assets obtained at the step 210 may be a template set of graphics assets defined in advance for a portion of a video game and providing an initial set of graphics assets intended to be modified. Techniques using a template set of graphics assets are discussed in more detail later.

More generally, in some embodiments of the disclosure the method 200 may comprise obtaining a set of initial graphics assets for a video game from a storage source, in which the set of initial graphics assets may be one from the list consisting of: a set of initial graphics assets for an existing video game; a set of initial graphics assets for a portion of the existing video game; a template set of initial graphics assets providing a minimum set of graphics assets for a video game; and a template set of initial graphics assets providing a minimum set of graphics assets for a portion of a video game.

As explained above, a respective initial graphics asset comprises at least initial model data and optionally initial texture data for a respective object. In the case of using assets from an existing video game, each asset may comprise model data (e.g. polygonal mesh data and/or point cloud data) and texture data. In the case of using a template set of graphics assets, some or all of the graphics assets may comprise only model data and may be deliberately provided without texture data.

The set of initial graphics assets for the video game may be a template set of graphics assets defined in advance for a portion of the video game for providing an initial set of graphics assets to be modified for the portion of the video game. In some examples, a template set of graphics assets may comprise one or more first initial graphics assets comprising both initial model data and initial texture data and also one or more second initial graphics assets comprising initial model data without associated initial texture data. The first initial graphics assets may correspond to objects in a scene or level of a video game (e.g. characters) and for which modification is not to be performed, and the second initial graphics assets may correspond to other objects in the scene or level (e.g. non-character objects, such as landscape objects) and which can be modified to allow a scene to be given a certain appearance. Hence, modification of the set of initial graphics assets can potentially be performed whilst potentially allowing the first initial graphics assets (e.g. characters) to retain their initial appearance.

It will be appreciated the types of virtual object are not particularly limited and may vary from one video game to another. For example, in a driving game, the virtual objects may include object types such as cars, buildings and other objects types for use in generating landscape features (e.g. weather, trees and so on). In role playing games and/or shooter games, the virtual objects may include object types such as humanoid characters, non-humanoid characters, various weapons, vehicles, and so on. The set of initial graphics assets may thus comprise a plurality of respective model data (e.g. 2D or 3D model data) and a plurality of textures (also referred to as graphical textures) corresponding to a set of virtual objects for a video game (or portion thereof).

Hence more generally, in some embodiments of the disclosure the set of initial graphics assets obtained at the step 210 may comprise first model data and first texture data associated with a first virtual object, second model data and second texture data associated with a second virtual object and so on. The number of virtual objects is not particular limited and may generally be two or more.

In some embodiments of the disclosure, set of initial graphics assets corresponding to a template set of graphics assets may potentially comprise first initial model data associated with a first virtual object and second initial model data associated with a second virtual object and so on. For example, in the case of using a template set of graphics assets, initial texture data may or may not be provided for some or all of the virtual objects. For example, initial model data may be provided for a virtual object and which it is intended to be used with a texture that is to be generated based on the machine learning techniques. Hence, the initial model data may serve as a base to which a machine learning generated image is to be applied for providing a visual appearance that is related to the content of the text data.

Of course, in some cases the template set of graphics assets may also comprise initial texture data associated with the initial model data. In this case, images generated using the machine learning model can be used to replace (partially or wholly) the initial textures and/or generate pairings of textures and models for additional virtual objects using the initial model data and images generated using the machine learning model.

Hence more generally, in the method 200 the set of initial graphics assets for the video game is obtained. One or more respective images are generated using the machine learning model. The set of initial graphics assets is modified in dependence upon one or more of the images generated using the machine learning model so as to obtain a modified set of graphics assets which can provide a potentially bespoke visual appearance for the set of initial graphics assets, depending on the text data, to thereby provide a potentially bespoke gaming experience.

### Text Data Examples

The text data obtained at the step 220 can be input to the machine learning model to thereby generate one or more images. The text data may potentially be obtained from a variety of sources and thus a variety of possible images related to the content of the text data may be generated.

In some embodiments of the disclosure, the step 220 of obtaining the text data may comprise obtaining the text data from one or more sources comprising one or more of: one or more books; one or more electronic books; one or more audio books; one or more movies; and one or more other video games. For example, the text data may be obtained from a book (or electronic book) such as a fiction book. The text data may be obtained from a chapter or other similar sub-section of a book so as to generate one more images in dependence on the text data from the chapter/sub-section using the machine learning model. In this way, one or more images can be generated in accordance with a descriptive content of the text data from the chapter/sub-section. For example, the text data may correspond to a section of a book such as a book from the Lord of the Rings® book series or one or more other similar books. A source used for obtaining the text data is not particularly limited and a fiction book is one possible example. One or more of the machine learning generated images can be generated and used to modify the set of initial graphics assets to obtain modified set of graphics assets.

In some examples, the step 220 of obtaining the text data may comprise obtaining one or more images comprising the text data. Images including various indicia may be obtained and processing using known techniques to extract text data from images may be used. For example, one or more photographs may be captured by a user. Such photographs may include pages of a physical book and may be processed to extract text data for use in the method 200. For example, a user may desire to have a gaming experience that relates to a specific portion of the book (e.g. a certain page or a certain chapter or more generally some other portion of the book) and can capture images of the relevant text (e.g. using a camera such as that provided with a smartphone device). Any suitable image-to-text conversion (e.g. optical character recognition and/or machine learning techniques) may be used for extraction of the text data.

In some examples, the step 220 of obtaining the text data may comprise obtaining one or more audio recordings. An audio recording associated with an audiobook and/or a movie may be obtained. Any known speech-to-text conversion may be used for extraction of the text data.

In some examples, the obtained text data may relate to a video game that is different from a video game associated with the set of initial graphics assets. Put differently, the obtained set of initial graphics assets may be generated in advance for a first video game, and using the obtained text data indicative of a natural language description for a second video game (e.g. potentially from a same or different video game series, and/or potentially of a different genre) one or more images can be generated and used for modification of the set of initial graphics assets.

Hence more generally, the method 200 comprises obtaining the text data from one or more sources. The text data may be indicative of a natural language description for a content item such as a book, movie and/or video game of any suitable genre. At the step 230, the method 200 comprises inputting at least some of the text data to the machine learning model. The machine learning model is trained to generate and output one or more images in dependence on the input comprising at least some of the text data. The training of the machine learning model, and the training data, can take a number of different forms which are discussed in turn below. More generally, in response to an input comprising text data, the machine learning model is operable to generate and output at least one image.

### Machine Learning for Generating Images

In some embodiments of the disclosure, the machine learning model comprises a text-to-image model trained to generate a plurality of respective images in dependence upon a natural language description indicated by the text data. Any suitable text-to-image machine learning model may be used (a possible example for this may be the DeepAI® image generator or other similar image generator). The text data comprising a natural language description can be input to the text-to-image model to obtain one or more images visually depicting objects having an appearance corresponding to the natural language description.

FIG. 4 is a schematic flowchart illustrating a method representing a possible technique for performing the method 200 discussed above with respect to FIG. 2.

At a step 430 at least some of the obtained text data is input to the machine learning model.

At a step 440, one or more images are generated using the machine learning model. The images are generated in dependence on the text data using the machine learning model. The text data may be indicative of a natural language description of a visual appearance of an entity such as a character (e.g. a humanoid character or non-humanoid character), a building or other similar object such as a background object. Similarly, the text data may include a natural language description of a visual appearance of a scene. Therefore, one or more images can be generated accordingly for the text data provided as an input to the machine learning model. More generally, the text data may comprise one or more words and/or sentences from a content item such as a book, ebook, audio book, movie and so on, and using the machine learning model one or more images can be generated for visually depicting one or more objects according to the words and/or sentences.

At a step 450, the set of initial graphics assets for the video game is modified in dependence upon one or more of the images generated using the machine learning model. Modifying the set of initial graphics assets may comprise one or more from the list consisting of:
i) associating a respective image with initial model data for a given object for using the respective image as a texture for the initial model data;
ii) modifying initial texture data for a given object in dependence upon a respective image to obtain modified texture data for the given object (e.g. replacing (partially or wholly) an initial texture associated with a given virtual object with a generated image);
iii) associating initial model data for one or more virtual objects with one or more of the generated images so as to add one or more new virtual objects to the set of initial graphics assets; and/or
iv) associating initial model data for one or more virtual objects with one or more of the generated textures so as to add a texture to a virtual object that may have been initially provided with no initial texture (e.g. as in the case of providing a template set comprising model data without corresponding textures).

In relation to item i) in the above list, a respective image generated using the text-to-image machine learning model may be associated with initial model data for a given object for using the respective image at least partially (e.g. partially or wholly) as a texture for the initial model data. The initial model data for the given object may or may not have corresponding initial texture data. Hence, in some cases the associating results in the associated image being used as the texture for the initial model data. In other cases, initial model data for the given object may have a corresponding initial texture and the associating may result in directly substituting (replacing) the initial texture with a texture generated using the machine learning model. Hence, an initial texture for a given virtual object may be replaced with another texture such that the modified set of graphics assets can be used for providing a gaming experience with a visual appearance related to the text data (e.g. related to a chapter in a given book). Similarly, an initial texture may be partially replaced or modified using an image generated using the machine learning model. For example, an initial texture associated with a character in a game may be modified to retain a portion (e.g. associated with a character's face) whilst replacing or modifying another portion (e.g. associated with the character's clothing). For example, an initial texture may have associated setting information for defining one or more regions of the initial texture for which modification is permitted (with modification not being permitted for other regions). Alternatively, or in addition to, an initial texture associated with an object may be blended (e.g. pixel value blending) with an image generated using the machine learning model. Hence in some cases a generated image and an initial texture may be used in combination, and a scale factor (e.g. a value between 1 and 0) may be used to control a contribution of the initial texture and the generated image for a resulting texture. As explained below, the generated image may in some cases have a certain image style and the strength of the image stylization may be controlled via such a scale factor.

Hence more generally, in some embodiments of the disclosure a respective image generated using the text-to-image machine learning model may be associated with initial model data for a given object for using the respective image as a texture for the initial model data. In this way, the initial model data can be used with a potentially bespoke texture (and/or using a potentially bespoke texture to modify an associated initial texture). Hence, model data generated in advance can be used with a potentially bespoke texture so as to allow an existing video game to be played with a modified appearance for at least some (or all) of the objects within a scene, level or other similar portion.

In relation to item iii) in the above list, initial model data (which may or may not already be associated with initial texture data) may be associated with a generated texture to add a virtual object to the set to thereby increase the number of virtual objects. For example, in response to the text data, two or more images corresponding to a same type of object (e.g. a background object such as trees, chairs, tables, cars, weather related objects and so on) may be generated. A first image of the two or more images may be associated with first initial model data for a same object type to generate another virtual object and similarly a second image of the two or more images may be associated with the first initial model to generate a further virtual object. In this way, same initial model data (e.g. model data for a given object such as a chair) may be used to generate two or more additional virtual objects using the images generated using the machine learning model. Moreover, a potentially large number of background objects each having an appearance that is relevant to the text data can thus be generated.

In relation to item iv) in the above list, the template set of graphics assets may potentially comprise only model data for a number of virtual objects and the generated images may be associated with instances of the initial model data so as to add textures to the virtual objects. Moreover, the set of initial graphics assets may comprise first polygonal mesh data for a first virtual object and second polygonal mesh data for a second virtual object. Images generated using the machine learning model can be associated with the polygonal mesh data for using the images as textures for the initial model data. In this way, a style and/or visual appearance that is relevant to the text data can be applied to at least some of the initial graphics assets. In some cases, the initial model data for a virtual object may already have a corresponding initial texture. In this case, the initial texture may be partially or wholly replaced and/or modified using a generated image.

### Machine Learning for Generating Images and Model Data

The above techniques refer to using initial model data included in the set of initial graphics assets with associated images generated using the machine learning model. In some embodiments of the disclosure, in the method 200 the step of generating (step 240) comprises generating one or more respective instances of model data each associated with a respective image of the one or more respective images generated using the machine learning model. Hence, in some embodiments machine learning techniques may be used to generate one or more respective images and to also generate one or more instances of model data. It will be appreciated that this can potentially allow for generation of model data different from that included in the set of initial graphics assets and in this way the set of initial graphics assets can be modified to include virtual objects having both a different model and a different texture.

FIG. 5 is a schematic flowchart illustrating a method representing another possible technique for performing the method 200 discussed above with respect to FIG. 2.

At a step 530 at least some of the obtained text data is input to the machine learning model.

At a step 540, one or more images are generated using the machine learning model. In addition, at the step 540 one or more respective instances of model data are generated in dependence on the least some of the plurality of respective images using a second machine learning model. The second machine learning model may be trained using labelled training data comprising images of objects (e.g. video game objects and/or real-world objects) and labels corresponding to model data for the objects to learn to map an image including an object to a label indicative of model data for that object. The following discussion refers to using the machine learning model (also referred to as the first machine learning model) and the second machine learning model, however, it will be appreciated that the functionality of the first machine learning model and the second machine learning model may in fact be provided solely by the first machine learning model, or two separate machine learning models may be used. Both possibilities are considered.

At a step 550, the set of initial graphics assets for the video game is modified in dependence upon one or more of the images generated using the machine learning model and one or more of the respective instances of model data generated using the second machine learning model. Modifying the set of initial graphics assets may include a number of possibilities such as any of the items i) to iv) listed previously with respect to FIG. 4.

In some embodiments of the disclosure, a respective image generated using the first machine learning model (text-to-image machine learning model) may be input to the second machine learning model for obtaining an instance of model data for the respective image. The respective image and the instance of model data can be associated with each other and included in the set of initial graphics assets. Therefore, a respective image including a given object having a given type and respective model data (e.g. a polygonal mesh) for the given object can be obtained using the two machine learning models. Inclusion in the set of initial graphics assets may include adding to the set of initial graphics assets so as to increase a number of virtual objects. Alternatively, inclusion in the set of initial graphics assets may include replacing a virtual object.

For example, the set of initial graphics assets may have been generated in advance for a given video game and the text data may be such that there is a natural language description for one or more objects of a different type to that included in the set. An example of this may be where the video game and the text data relate to content of different genres, such as a driving video game and text data associated with a high fantasy fiction book. Hence, for such cases, the second machine learning model may be operable to obtain an instance of model data for a respective image for thereby obtaining both model data and texture data for a suitable object.

More generally, some embodiments of the disclosure may use a second machine learning model to: receive an input comprising an image that has been generated in dependence on the text data; and generate and output data indicative of model data (e.g. one or more of point cloud data, polygonal mesh data) for the image. The second machine learning model may have been trained in a supervised manner using labelled training data comprising images of objects (e.g. video game objects) and labels corresponding to model data for the objects. For example, the second machine learning model may be trained using images from one or more video games that have been labelled with the corresponding model data for the objects included in the images. The training data may comprise images for a range of object types and also for a range of object size.

Hence more generally, in some embodiments of the disclosure the method 200 may comprise:
inputting (at the step 230) at least some of the text data to a machine learning model comprising a text-to-image model trained to generate a plurality of respective images in dependence upon the text data;
generating (at the step 240) one or more respective images in dependence on the text data using the machine learning model;
inputting one or more of the respective images to a second machine learning model, the second machine learning model having been trained using labelled training data comprising images of objects and labels corresponding to model data for the objects to learn to map an image including an object to a label indicative of model data for that object;
generating one or more respective instances of model data in dependence one or more of the respective images using the second machine learning model; and
modifying the set of initial graphics assets for the video game in dependence upon one or more of the respective images generated using the machine learning model and one or more of the respective instances of model data generated using the second machine learning model.

### Machine Learning for Mapping to Initial Graphics Assets

In some embodiments of the disclosure, the method 200 comprises inputting at least some of the set of initial graphics assets for the video game to the machine learning model. Hence, in some cases the method 200 comprises inputting both the text data and at least some of the set of initial graphics assets to one or more machine learning models. The text data may be input to a first machine learning model (text-to-image machine learning model) and the at least some of the set of initial graphics assets may be input to another machine learning model (herein referred to as a third machine learning model so as to distinguish from the other previously mentioned machine learning models). The following discussion refers to using the first machine learning model and the third machine learning model, however, it will be appreciated that the functionality of the first machine learning model and the third machine learning model may in fact be provided solely by the first machine learning model.

The third machine learning model can be operable to map at least some of the respective images generated using the first machine learning model to at least some of the initial graphics assets so as to map a respective image to an initial graphics asset corresponding to a same object type. A potentially large number of respective images may be generated using the first machine leaning model in dependence on the text data. For example, the text data may correspond to several pages (or all) of a book. Alternatively, or in addition to, the set of initial graphics assets may comprise a potentially large number of instances of initial model data for a potentially large number of objects. For example, the set of initial graphics assets may corresponds to a level, scene or an entirety of a video game.

For example, the method 200 may comprise inputting text data for an entirety of a book (or other similar content item) and also inputting a set of initial graphics assets corresponding to an entirety (or a level) of an existing video game. Hence, the number of generated images and/or the number of virtual objects associated with the set of initial graphics assets may potentially be of the order of tens, hundreds or even thousands.

The third machine learning model is operable to receive the respective images and also at least some of the set of initial graphics assets for the video game and map at least some of the respective images to at least some of the initial graphics assets. In this way, the images (which are generated according to the natural language description indicated by the text data) can be appropriately mapped to the initial assets to allow the image to be used as textures for appropriate objects. For example, the third machine learning model may be trained in a supervised manner using labelled training data comprising images of objects and labels corresponding to object types to learn to output a classification indicative of one or more object types for a given input image. In addition, the third machine learning model may have also been trained in a supervised manner using labelled training data comprising graphics assets each comprising at least model data and optionally texture data, with each graphics asset being labelled with an object type, so as to learn to output a classification indicative of one or more object types for a given input graphics asset. In this way, the generated images and the initial graphics assets can be classified according to object type and images can be mapped to initial graphics assets of a same object type.

With respect to the above-mentioned labelled training data, the labels may indicate object type and also an object size. For example, a plurality of object size classifications may be used for one or more object types for allowing a further classification for that object type according to a size. An example of this may be classifying a human character as being small, average or large. It will be appreciated that two or more object size classification may be used in this way.

Hence more generally, using both the text data and the set of initial graphics assets for the video game, images can be generated and mapped to the set of initial graphics assets, and a respective initial graphics assets can be modified in dependence upon the image mapped to that respective initial graphics asset. This can potentially allow a whole book (or a chapter of a book) to be used to obtain an image set which can be used to intelligently modify a set of initial graphics assets for a video game in a way that can allow a bespoke visual appearance for the set of initial graphics assets depending on the text data. For example, the set of initial assets may correspond to a level or scene in an existing video game, and the modified set of initial assets (obtained by modifying the set of initial assets according to the techniques discussed above) can be used during execution of the video game by a processing device (e.g. apparatus 300 or another apparatus) to allow the video game to be played but with a different visual appearance that may have a style related to the natural language description indicated by the text data.

In some embodiments of the disclosure, each of the one or more respective images has a same image style and the step of modifying causes at least some (in some cases, each) of the initial graphics assets to be modified to apply a style transfer. In some embodiments of the disclosure, the text data is input to a machine learning model comprising a text-to-image machine learning model and the text-to-image machine learning model may be operable to generate the images having a same image style. For example, an image style such as one or more from the list consisting of: wintry; summery; autumnal; woodland; industrial; moonscape and so on may be identified based on the text data and used for generating the images. Alternatively, the text data may be input to a text-to-image machine learning model and the images generated using the text-to-image machine learning model may be input to a further machine learning model that is trained to apply a style transfer to the images according to an image style which is identified based on the text data. For example, one or more reference style images may be identified based on the text data and applied, by the further machine learning model, to each of the generated images.

As explained previously, some embodiments of the disclosure provide a template set of graphics assets (also referred to as a base set of assets) which may have been created in advance so as to serve as a template to be modified to obtain a modified set of graphics assets. In some embodiments of the disclosure, the template set of graphics assets may comprise one or more first initial graphics assets and one or more second initial graphics assets. The first initial graphics assets and the second initial graphics assets may each comprise both initial model data and initial texture data. Alternatively, in some cases the second initial graphics assets may comprise initial model data without corresponding texture data. More generally, the initial graphics assets can be grouped into the two groups so that first initial graphics assets are not to be modified whereas second initial graphics assets are available for being modified.

Similarly, in some embodiments of the disclosure, the set of initial graphics assets for the video game may correspond to a complete set of a graphics assets for an existing video game and a developer may manually specify one or more of the initial graphics assists as being first initial graphics assets so as not to be modified. For example, the set of initial graphics assets may correspond to a scene such as a woodland scene including a river, trees and other foliage to be traversed by one or more characters (e.g. player character and/or non-player characters). In some examples, portions of the scene corresponding to player objects can be categorised as first initial graphics assets. Other remaining portions can be categorised as second initial graphics assets (either by being explicitly categorised or not being categorised as a first initial graphics asset). In this way, parts of a scene can be modified according to the techniques discussed above so as to provide a scene with a visual appearance that is based on the text data whilst allowing a character (e.g. player character) or other object to remain unmodified. More generally, within a set of initial graphics assets, a subset of the set of initial graphics can be designated so as not to be modified. In this way, certain aspects of the initial model data and/or initial texture data may be preserved whilst allowing other aspects to be modified for providing a potentially bespoke gaming experience for the video game which is relevant to the text data.

Hence more generally, in some embodiments of the disclosure the set of initial graphics assets comprises one or more first initial graphics assets and one or more second initial graphics assets, and the step 250 of modifying comprises modifying one or more of the second initial graphics assets without modifying the one or more first initial graphics assets.

It will be appreciated that example embodiments can be implemented by computer software operating on a general purpose computing system such as a games machine. In these examples, computer software, which when executed by a computer, causes the computer to carry out any of the methods discussed above is considered as an embodiment of the present disclosure. Similarly, embodiments of the disclosure are provided by a non-transitory, machine-readable storage medium which stores such computer software.

It will also be apparent that numerous modifications and variations of the present disclosure are possible in light of the above teachings. It is therefore to be understood that within the scope of the appended claims, the disclosure may be practised otherwise than as specifically described herein.

Example(s) of the present technology are defined by the following numbered clauses:
1. A computer-implemented method comprising:
   obtaining a set of initial graphics assets for a video game, an initial graphics asset comprising at least initial model data for an object;
   obtaining text data from one or more sources;
   inputting at least some of the text data to a machine learning model;
   generating one or more respective images in dependence on the text data using the machine learning model; and
   modifying the set of initial graphics assets for the video game in dependence upon one or more of the respective images generated using the machine learning model.
2. The method according to clause 1, wherein the machine learning model comprises a text-to-image model trained to generate a plurality of respective images in dependence upon a natural language description indicated by the text data.
3. The method according to clause 2, wherein the step of modifying comprises associating a respective image with initial model data for a given object for using the respective image as a texture for the initial model data.
4. The method according to clause 2, wherein the step of modifying comprises modifying initial texture data for a given object in dependence upon a respective image to obtain modified texture data for the given object.
5. The method according to any preceding clause, wherein the step of generating comprises generating one or more respective instances of model data each associated with a respective image of the one or more respective images.
6. The method according to clause 5, wherein the machine learning model comprises a text-to-image model to generate a plurality of respective images in dependence upon the text data and the method comprises:
   inputting at least some of the plurality of respective images to a second machine learning model; and
   generating the one or more respective instances of model data in dependence on the least some of the plurality of respective images using the second machine learning model, the second machine learning model having been trained using labelled training data comprising images of objects and labels corresponding to model data for the objects to learn to map an image including an object to a label indicative of model data for that object.
7. The method according to clause 1, comprising inputting at least some of the set of initial graphics assets for the video game to the machine learning model.
8. The method according to clause 7, comprising mapping at least some of the respective images to at least some of the initial graphics assets using the machine learning model so as to map a respective image to an initial graphics asset corresponding to a same object type.
9. The method according to any preceding clause, wherein modifying the set of initial graphics assets for the video game comprises one or more of:
   adding one or more graphics assets to the set of initial graphics assets; and
   modifying initial texture data for one or more of the initial graphics assets in dependence on one or more of the respective images.
10. The method according to any preceding, wherein each of the one or more respective images has a same image style and the step of modifying causes at least some of the initial graphics assets to be modified to apply a style transfer.
11. The method according to any preceding clause, wherein the set of initial graphics assets for the video game corresponds to a portion of the video game.
12. The method according to clause 11, wherein the portion of the video game is one of:
   a spatial portion of a computer generated environment for the video game;
   a level within the video game; and
   a scene within the video game.
13. The method according to any preceding clause, wherein the set of initial graphics assets for the video game is a template set of graphics assets defined in advance for the portion of the video game for providing a set of initial graphics assets to be modified for a portion of the video game.
14. The method according to clause 13, wherein the set of initial graphics assets comprises one or more first initial graphics assets and one or more second initial graphics assets, and the step of modifying comprises modifying one or more of the second initial graphics assets without modifying the one or more first initial graphics assets.
15. The method according to any preceding clause, comprising obtaining the text data from one or more sources comprising one or more from the list consisting of:
   one or more books;
   one or more audio books;
   one or more movies; and
   one or more other video games.
16. A computer program comprising instructions which, when executed by a computer, cause the computer to perform the method according to any one of clauses 1-15.
17. A data processing apparatus comprising;
   obtaining circuitry to obtain a set of initial graphics assets for a video game and text data from one or more sources, each initial graphics asset comprising at least initial model data for an object; and
   processing circuitry to
   input at least some of the text data to a machine learning model;
   generate one or more respective images in dependence on the text data using the machine learning model; and
   modify the set of initial graphics assets for the video game in dependence upon one or more of the respective images generated using the machine learning model.

What is claimed is:

1. A computer-implemented method comprising:
obtaining a set of initial graphics assets for a video game, an initial graphics asset comprising at least initial model data for an object;
obtaining text data from one or more sources;
inputting at least some of the text data to a machine learning model;
generating one or more respective images in dependence on the text data using the machine learning model; and
modifying the set of initial graphics assets for the video game in dependence upon one or more of the respective images generated using the machine learning model.

2. The computer-implemented method according to claim 1, wherein the machine learning model comprises a text-to-image model trained to generate a plurality of respective images in dependence upon a natural language description indicated by the text data.

3. The computer-implemented method according to claim 2, wherein the step of modifying comprises associating a respective image with initial model data for a given object for using the respective image as a texture for the initial model data.

4. The computer-implemented method according to claim 2, wherein the step of modifying comprises modifying initial texture data for a given object in dependence upon a respective image to obtain modified texture data for the given object.

5. The computer-implemented method according to claim 1, wherein the step of generating comprises generating one or more respective instances of model data each associated with a respective image of the one or more respective images.

6. The computer-implemented method according to claim 5, wherein the machine learning model comprises a text-to-image model to generate a plurality of respective images in dependence upon the text data and the method comprises:
inputting at least some of the plurality of respective images to a second machine learning model; and
generating the one or more respective instances of model data in dependence on the least some of the plurality of respective images using the second machine learning model, the second machine learning model having been trained using labelled training data comprising images of objects and labels corresponding to model data for the objects to learn to map an image including an object to a label indicative of model data for that object.

7. The computer-implemented method according to claim 1, comprising inputting at least some of the set of initial graphics assets for the video game to the machine learning model.

8. The computer-implemented method according to claim 7, comprising mapping at least some of the respective images to at least some of the initial graphics assets using the machine learning model so as to map a respective image to an initial graphics asset corresponding to a same object type.

9. The computer-implemented method according to claim 1, wherein modifying the set of initial graphics assets for the video game comprises one or more of:
adding one or more graphics assets to the set of initial graphics assets; and
modifying initial texture data for one or more of the initial graphics assets in dependence on one or more of the respective images.

10. The computer-implemented method according to claim 1, wherein each of the one or more respective images has a same image style and the step of modifying causes at least some of the initial graphics assets to be modified to apply a style transfer.

11. The computer-implemented method according to claim 1, wherein the set of initial graphics assets for the video game corresponds to a portion of the video game.

12. The computer-implemented method according to claim 11, wherein the portion of the video game is one of:
a spatial portion of a computer generated environment for the video game;
a level within the video game; and
a scene within the video game.

13. The computer-implemented method according to claim 1, wherein the set of initial graphics assets for the video game is a template set of graphics assets defined in advance for a portion of the video game for providing a set of initial graphics assets to be modified for the portion of the video game.

14. The computer-implemented method according to claim 13, wherein the set of initial graphics assets comprises one or more first initial graphics assets and one or more second initial graphics assets, and the step of modifying comprises modifying one or more of the second initial graphics assets without modifying the one or more first initial graphics assets.

15. The computer-implemented method according to claim 1, comprising obtaining the text data from one or more sources comprising one or more from the list consisting of:
one or more books;
one or more audio books;
one or more movies; and
one or more other video games.

16. A non-transitory computer-readable storage medium storing a computer program comprising instructions which, when executed by a computer, cause the computer to:
obtain a set of initial graphics assets for a video game, an initial graphics asset comprising at least initial model data for an object;
obtain text data from one or more sources;
input at least some of the text data to a machine learning model;
generate one or more respective images in dependence on the text data using the machine learning model; and
modify the set of initial graphics assets for the video game in dependence upon one or more of the respective images generated using the machine learning model.

17. The non-transitory computer-readable storage medium of claim 16, wherein the machine learning model comprises a text-to-image model trained to generate one or more of respective images in dependence upon a natural language description indicated by the text data.

18. The non-transitory computer-readable storage medium of claim 17, wherein the set of initial graphics assets is modified by at least associating a respective image with initial model data for a given object for using the respective image as a texture for the initial model data.

19. The non-transitory computer-readable storage medium of claim 17, wherein the set of initial graphics assets is modified by at least modifying initial texture data for a given object in dependence upon a respective image to obtain modified texture data for the given object.

20. A data processing apparatus comprising:
one or more processors; and
one or more memories storing instructions that, upon execution by the one or more processors, cause the data processing apparatus to:
obtain a set of initial graphics assets for a video game and text data from one or more sources, each initial graphics asset comprising at least initial model data for an object;
input at least some of the text data to a machine learning model;
generate one or more respective images in dependence on the text data using the machine learning model; and
modify the set of initial graphics assets for the video game in dependence upon one or more of the respective images generated using the machine learning model.
